(19) United States
(12) Patent Application Publication
(10) Pub. No.: US 2026/0170990 A1
(43) Pub. Date: Jun. 18, 2026

(54) Display Panel and Display Apparatus

(71) Applicants: CHENGDU BOE OPTOELECTRONICS TECHNOLOGY CO., LTD., Chengdu, Sichuan (CN); BOE TECHNOLOGY GROUP CO., LTD., Chaoyang District, Beijing (CN); BEIJING BOE TECHNOLOGY DEVELOPMENT CO., LTD., Beijing (CN)

(72) Inventors: Ting Han, Beijing (CN); Fei Fang, Beijing (CN); Chienpang Huang, Beijing (CN); Bo Peng, Beijing (CN); Linchang He, Beijing (CN); Yuanzhang Zhu, Beijing (CN)

(21) Appl. No.: 18/711,716

(22) PCT Filed: Jul. 7, 2023
(86) PCT No.: PCT/CN2023/106409

§ 371 Date: May 20, 2024

(51) Int. Cl. G09G 3/20; G09G 3/3233

(52) U.S. Cl. CPC G09G 3/2074; G09G 3/3233; G09G 2300/026; G09G 2300/0426; G09G 2300/0819; G09G 2300/0852; G09G 2300/0861

(57) ABSTRACT

A display panel includes first sub-pixels, second sub-pixels, and first and second signal lines. The second sub-pixels at least partially surround the first sub-pixels. The first signal lines are electrically connected to the first sub-pixels and are configured to transmit at least one of a first positive voltage signal, first negative voltage signal, first initial voltage signal and a data signal to the first sub-pixels. The second signal lines are electrically connected to at least part of the second sub-pixels and are configured to transmit at least one of a second positive voltage signal, second negative voltage signal, second initial voltage signal and another data signal to the at least part of the second sub pixels. A first sub-pixel and a second sub-pixel display a same gray scale, and a luminance of the first sub-pixel is less than a luminance of the second sub-pixel.

### CROSS-REFERENCE TO RELATED APPLICATION

This application is the United States national phase of International Patent Application No. PCT/CN 2023/106409, filed Jul. 7, 2023, the disclosure of which is hereby incorporated by reference in its entirety.

### BACKGROUND OF THE INVENTION

### Field of the Invention

The present disclosure relates to the field of display technologies, and in particular, to a display panel and a display apparatus.

### Description Of Related Art

With the rapid development of display technology, large format display (LFD) technology has gradually become the development demand of the display industry; multiple display panels are used to be tiled together to form an oversized tiled display apparatus (a tiled screen), which is one of the main manners to achieve large format display. There are seams between the multiple display panels included in the tiled display apparatus. How to weaken the impact of the seams on the tiled display apparatus is an urgent problem that needs to be solved in current tiled screens.

### SUMMARY OF THE INVENTION

In an aspect, a display panel is provided. The display panel includes a plurality of first sub-pixels, a plurality of second sub-pixels, first signal lines and second signal lines. The plurality of second sub-pixels at least partially surround the plurality of first sub-pixels. The first signal lines are electrically connected to the first sub-pixels and are configured to transmit at least one of a first positive voltage signal, a first negative voltage signal, a first initial voltage signal and a data signal to the first sub-pixels. The second signal lines are electrically connected to at least part of the plurality of second sub-pixel, and are configured to transmit at least one of a second positive voltage signal, a second negative voltage signal, a second initial voltage signal and another data signal to the at least part of the plurality of second sub-pixels. A first sub-pixel and a second sub-pixel display a same gray scale, and a luminance of the first sub-pixel is less than a luminance of the second sub-pixel.

In some embodiments, the first signal lines include first positive voltage signal lines, and a first positive voltage signal line is configured to transmit the first positive voltage signal; the second signal lines include at least one second positive voltage signal line, a second positive voltage signal line is configured to transmit the second positive voltage signal. A voltage value of the first positive voltage signal is less than a voltage value of the second positive voltage signal.

In some embodiments, the plurality of second sub-pixels surround the plurality of first sub-pixels. The at least one second positive voltage signal line each extends a peripheral edge of the plurality of first sub-pixels and the at least one second positive voltage signal line is electrically connected to the second sub-pixels. The display panel includes a plurality of conductive layers, and the first positive voltage signal lines and the at least one second positive voltage signal line are located in different conductive layers.

In some embodiments, the at least part of the plurality of second sub-pixels are arranged in a plurality of columns, and at least one column of second sub-pixels is arranged on each of both sides, in a first direction, of the plurality of first sub-pixels; a column of second sub-pixels includes second sub-pixels arranged in a second direction; the first direction and the second direction intersect. The display panel includes a plurality of second positive voltage signal lines, and each second positive voltage signal line is electrically connected to a respective column of second sub-pixels. The display panel includes a plurality of conductive layers, and the first positive voltage signal lines and the second positive voltage signal lines are arranged in a same layer.

In some embodiments, the display panel has a display area and a peripheral area, and the plurality of first sub-pixels and the plurality of second sub-pixels are located in the display area; the peripheral area surrounds the display area. The display panel further includes a positive voltage signal bus arranged in the peripheral area and surrounding the display area; the first positive voltage signal lines and the at least one second positive voltage signal line are both electrically connected to the positive voltage signal bus, and a line width of the first positive voltage signal line is less than a line width of the second positive voltage signal line. Alternatively, the display panel further includes a first positive voltage signal bus and a second positive voltage signal bus; the first positive voltage signal bus is arranged in the peripheral area, surrounds the display area, and is configured to transmit the first positive voltage signal; the second positive voltage signal bus is arranged in the peripheral area, surrounds the display area, and is configured to transmit the second positive voltage signal; the first positive voltage signal lines are electrically connected to the first positive voltage signal bus, and the at least one second positive voltage signal line is electrically connected to the second positive voltage signal bus.

In some embodiments, the display panel has a display area and a peripheral area, the plurality of first sub-pixels and the plurality of second sub-pixels are located in the display area; and the peripheral area surrounds the display area. The display panel further includes a first positive voltage signal bus and a second positive voltage signal bus. The first positive voltage signal bus is arranged in the peripheral area and surrounds the display area, and the first positive voltage signal bus is configured to transmit the first positive voltage signal. The second positive voltage signal bus is arranged in the peripheral area and surrounds the display area, and the second positive voltage signal bus is configured to transmit the second positive voltage signal; the first positive voltage signal lines are electrically connected to the first positive voltage signal bus, and the second positive voltage signal lines are electrically connected to the second positive voltage signal bus. Alternatively, the display panel further includes a positive voltage signal bus arranged in the peripheral area and surrounding the display area; the first positive voltage signal lines and the second positive voltage signal lines are both electrically connected to the positive voltage signal bus, and a line width of the first positive voltage signal line is less than a line width of the second positive voltage signal line.

In some embodiments, the first sub-pixel includes a first pixel circuit and a first light-emitting device, the first pixel circuit includes a first node, and the first node is electrically connected to the first light-emitting device. The second sub-pixel includes a second pixel circuit and a second light-emitting device, the second pixel circuit includes a second node, and the second node is electrically connected to the second light-emitting device. The first signal lines include first initial voltage signal lines, and a first initial voltage signal line is configured to transmit the first initial voltage signal and is configured to initialize the first node. The second signal lines include at least one second initial voltage signal line, and a second initial voltage signal line is configured to transmit the second initial voltage signal and is configured to initialize the second node. A voltage value of the first initial voltage signal is less than a voltage value of the second initial voltage signal.

In some embodiments, the plurality of second sub-pixels surround the plurality of first sub-pixels. The at least one second initial voltage signal line each extend along a peripheral edge of the plurality of first sub-pixels, and the at least one second initial voltage signal line is electrically connected to the plurality of second sub-pixels. The display panel includes a plurality of conductive layers, and the first initial voltage signal lines and the at least one second initial voltage signal line are located in different conductive layers.

In some embodiments, the at least part of the plurality of second sub-pixels are arranged in a plurality of rows, and at least one row of second sub-pixels is arranged on each of both sides, in a second direction, of the plurality of first sub-pixels; a row of second sub-pixels includes second sub-pixels arranged in a first direction; the first direction and the second direction intersect. The display panel includes a plurality of second initial voltage signal lines, and each second initial voltage signal line is electrically connected to a respective row of second sub-pixels. The display panel includes a plurality of conductive layers, and the first initial voltage signal lines and the second initial voltage signal lines are arranged in a same layer.

In some embodiments, the first sub-pixel includes a first light-emitting device, and the second sub-pixel includes a second light-emitting device. The first signal lines include a first negative voltage signal line, and the first negative voltage signal line is configured to transmit the first negative voltage signal and is configured to be electrically connected to a cathode of the first light-emitting device. The second signal lines include a second negative voltage signal line, and the second negative voltage signal line is configured to transmit the second negative voltage signal and is configured to be electrically connected to a cathode of the second light-emitting device. A voltage value of the first negative voltage signal is less than a voltage value of the second negative voltage signal.

In some embodiments, the first negative voltage signal line and the second negative voltage signal line are arranged in a same layer, and the first negative voltage signal line and the second negative voltage signal line have a gap therebetween.

In some embodiments, the first signal lines include first data signal lines, and a first data signal line is configured to transmit the data signal; and the second signal lines include second data signal lines, and a second signal line is configured to transmit the another data signal. A resistance of the first data signal line is less than a resistance of the second data signal line.

In some embodiments, the plurality of second sub-pixels surround the plurality of first sub-pixels. The display panel includes a plurality of conductive layers, and the first data signal lines and the second data signal lines are located in different conductive layers; a resistivity of a material of the first data signal lines is less than a resistivity of a material of the second data signal lines.

In some embodiments, the at least part of the plurality of second sub-pixels are arranged in a plurality of columns, and at least one column of second sub-pixels is arranged on each of both sides, in a first direction, of the plurality of first sub-pixels; a column of second sub-pixels includes second sub-pixels arranged in a second direction. The first direction and the second direction intersect. Each second data signal line is electrically connected to a respective column of second sub-pixels. The display panel includes a plurality of conductive layers. The first data signal lines and the second data signal lines are located in a same conductive layer, and a line width of the first data signal line is greater than a line width of the second data signal line.

In some embodiments, the first sub-pixel includes a first driving transistor and a first capacitor, and a plate of the first capacitor is electrically connected to a gate of the first driving transistor. The second sub-pixel includes a second driving transistor and a second capacitor, and a plate of the second capacitor is electrically connected to a gate of the second driving transistor. A capacitance of the second capacitor is greater than a capacitance of the first capacitor.

In some embodiments, a facing area between at least two plates included in the second capacitor is greater than a facing area between at least two plates included in the first capacitor.

In some embodiments, a number of plates included in the second capacitor is greater than a number of plates included in the first capacitor.

In some embodiments, the first sub-circuit includes a first driving transistor, and the second sub-circuit includes a second driving transistor. A width-to-length ratio of a channel structure of the first driving transistor is less than a width-to-length ratio of a channel structure of the second driving transistor.

In some embodiments, the display panel has a display area and a bonding area located on a side of the display area, and the bonding area is provided with connection pins and dummy pins therein. The first signal lines are electrically connected to the connection pins, and the second signal lines are electrically connected to the connection pins and/or the dummy pins.

In another aspect, a display apparatus is provided. The display apparatus includes a plurality of display panels each as described in any of the above embodiments; two adjacent display panels have a seam therebetween, a display panel of the two adjacent display panels includes a first side proximate to the seam, and second sub-pixels in the display panel are closer to the first side than first sub-pixels in the display panel.

### BRIEF DESCRIPTION OF THE DRAWINGS

In order to describe technical solutions in the present disclosure more clearly, the accompanying drawings to be used in some embodiments of the present disclosure will be introduced briefly; obviously, the accompanying drawings to be described below are merely drawings of some embodiments of the present disclosure, and a person of ordinary skill in the art can obtain other drawings according to those drawings. In addition, the accompanying drawings in the following description may be regarded as schematic diagrams, but are not limitations on actual sizes of products, actual processes of methods and actual timings of signals involved in the embodiments of the present disclosure.

FIG. 1 is a structural diagram of a display apparatus, in accordance with some embodiments;

FIG. 2 is a plane view of a display panel, in accordance with some embodiments;

FIG. 3 is a sectional view of a display panel, in accordance with some embodiments;

FIG. 4 is an equivalent circuit diagram of a pixel circuit, in accordance with some embodiments;

FIG. 5 is a structural diagram of a display panel in which first signal lines and second signal lines are included, in accordance with some embodiments; and

FIGS. 6 to 15 are each a structural diagram of a display panel, in accordance with some embodiments.

### DESCRIPTION OF THE INVENTION

The technical solutions in embodiments of the present disclosure will be described clearly and completely with reference to the accompanying drawings. Obviously, the described embodiments are merely some but not all of embodiments of the present disclosure. All other embodiments obtained on the basis of the embodiments of the present disclosure by a person of ordinary skill in the art shall be included in the protection scope of the present disclosure.

Unless the context requires otherwise, throughout the description and claims, the term “comprise” and other forms thereof such as the third-person singular form “comprises” and the present participle form “comprising” are construed as an open and inclusive meaning, i.e., “included, but not limited to”. In the description of the specification, terms such as “one embodiment”, “some embodiments”, “exemplary embodiments”, “example”, “specific example” or “some examples” are intended to indicate that specific features, structures, materials or characteristics related to the embodiment(s) or example(s) are included in at least one embodiment or example of the present disclosure. Schematic representations of the above terms do not necessarily refer to the same embodiment(s) or example(s). In addition, specific features, structures, materials, or characteristics described herein may be included in any one or more embodiments or examples in any suitable manner.

Hereinafter, the terms such as “first” and “second” are used for descriptive purposes only, but are not to be construed as indicating or implying the relative importance or implicitly indicating the number of indicated technical features. Thus, a feature defined with “first” or “second” may explicitly or implicitly include one or more of the features. In the description of the embodiments of the present disclosure, the term “a plurality of” or “the plurality of” means two or more unless otherwise specified.

Some embodiments may be described using the terms “coupled”, “connected” and their derivatives. The term “connection” should be understood in a broad sense. For example, “connection” may be a fixed connection, a detachable connection, or an integrated connection; it may be a direct connection or an indirect connection through an intermediate medium. The term “coupled” indicates, for example, that two or more components are in direct physical or electrical contact. However, the term “coupled” or “communicatively coupled” may also indicate that two or more components are not in direct contact with each other, but still cooperate or interact with each other. The embodiments disclosed herein are not necessarily limited to the context herein.

The phrase “at least one of A, B and C” has the same meaning as the phrase “at least one of A, B or C”, both including following combinations of A, B and C: only A, only B, only C, a combination of A and B, a combination of A and C, a combination of B and C, and a combination of A, B and C.

The phrase “A and/or B” includes following three combinations: only A, only B, and a combination of A and B.

As used herein, the term “if” is, optionally, construed to mean “when” or “in a case where” or “in response to determining” or “in response to detecting”, depending on the context. Similarly, the phrase “if it is determined” or “if [a stated condition or event] is detected” is, optionally, construed to mean “in a case where it is determined” or “in response to determining” or “in a case where [the stated condition or event] is detected” or “in response to detecting [the stated condition or event]”, depending on the context.

The use of “applicable to” or “configured to” herein means an open and inclusive expression, which does not exclude devices that are applicable to or configured to perform additional tasks or steps.

Additionally, the use of the phrase “based on” is meant to be open and inclusive, since a process, step, calculation or other action that is “based on” one or more of the stated conditions or values may, in practice, be based on additional conditions or value beyond those stated.

The term such as “about”, “substantially” or “approximately” as used herein includes a stated value and an average value within an acceptable range of deviation of a particular value determined by a person of ordinary skill in the art, considering measurement in question and errors associated with measurement of a particular quantity (i.e., limitations of a measurement system).

The term such as “parallel”, “perpendicular” or “equal” as used herein includes a stated case and a case similar to the stated case within an acceptable range of deviation determined by a person of ordinary skill in the art, considering measurement in question and errors associated with measurement of a particular quantity (i.e., limitations of a measurement system). For example, the term “parallel” includes absolute parallelism and approximate parallelism, and an acceptable range of deviation of the approximate parallelism may be, for example, a deviation within 5°; the term “perpendicular” includes absolute perpendicularity and approximate perpendicularity, and an acceptable range of deviation of the approximate perpendicularity may also be, for example, a deviation within 5°; and the term “equal” includes absolute equality and approximate equality, and an acceptable range of deviation of the approximate equality may be, for example, that a difference between two equals is less than or equal to 5% of either of the two equals.

It will be understood that, when a layer or element is referred to as being on another layer or substrate, it may be that the layer or element is directly on the another layer or substrate, or it may be that intervening layer(s) exist between the layer or element and the another layer or substrate.

Exemplary embodiments are described herein with reference to sectional views and/or plan views as idealized exemplary drawings. In the accompanying drawings, thicknesses of layers and sizes of regions are enlarged for clarity. Variations in shape relative to the accompanying drawings due to, for example, manufacturing technologies and/or tolerances may be envisaged. Therefore, the exemplary embodiments should not be construed as being limited to the shapes of the regions shown herein, but including deviations due to, for example, manufacturing. For example, an etched region shown in a rectangular shape generally has a feature of being curved. Therefore, the regions shown in the accompanying drawings are schematic in nature, and their shapes are not intended to show actual shapes of the regions in an apparatus, and are not intended to limit the scope of the exemplary embodiments.

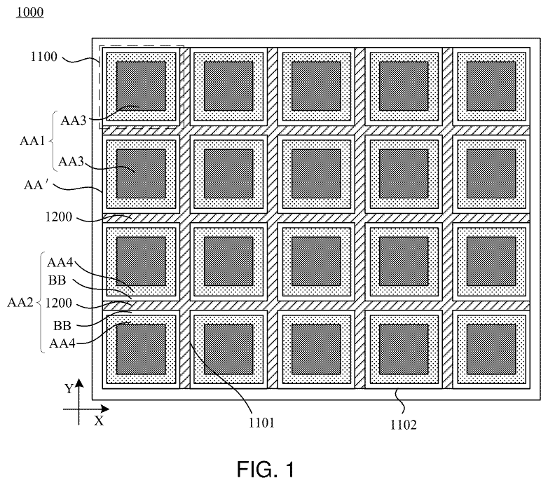

Referring to FIG. 1, FIG. 1 being a structural diagram of a tiled display apparatus, some embodiments of the present disclosure provide a display apparatus 1000. The display apparatus 1000 may be any apparatus that displays images whether in motion (e.g., videos) or stationary (e.g., still images) and whether text or images. The display apparatus 1000 may be a large-size display apparatus. For example, the display apparatus 1000 may be a tiled-screen display apparatus by using LFD technology, and the display apparatus 1000 is composed of a plurality of display panels 1100 tiled together.

The display apparatus 1000 is classified according to the light-emitting mode of the display apparatus 1000, the display apparatus 1000 may be a light-emitting diode (LED) liquid crystal tiled display apparatus, an organic light-emitting diode (OLED) self-luminescence tiled display apparatus, or a digital light processing (DLP) rear-projection tiled display apparatus. The OLED self-luminescence tiled display apparatus has the advantages such as self-luminescence and no light leakage. Moreover, compared with the liquid crystal display, the OLED self-luminescence tiled display apparatus also has a wider viewing angle, faster response, simple structure, and ultra-thin due to the absence of a liquid crystal layer, and it is easier to achieve high-end tiled display apparatuses such as seamless tiled, special-shaped tiled, and curved surface tiled display apparatuses. Therefore, the OLED self-luminescence tiled display apparatus has received more and more attention.

The following embodiments of the present disclosure will be schematically described by taking an example in which the display apparatus 1000 is an OLED self-luminescence tiled display apparatus. However, the embodiments of the present disclosure are not limited thereto and any other display apparatus may also be considered, as long as the same technical idea is applied.

As shown in FIG. 1, the display apparatus 1000 includes a plurality of display panels 1100, and the plurality of display panels 1100 are tiled together to form the display apparatus 1000. In a case where the display apparatus 1000 is an OLED self-luminescence tiled display apparatus, the display panels 1100 may each be an OLED display panel. Every two adjacent display panels 1100 have a seam 1200 therebetween. A side of the display panel 1100 proximate to the seam 1200 is a first side 1101, and a side of the display panel 1100 proximate to an edge of the display apparatus 1000 is a second side 1102.

For example, as shown in FIG. 1, the display apparatus 1000 includes 20 display panels 1100 arranged in an array (4 rows and 5 columns); sides of 6 display panels 1100 located in the middle of the display apparatus 1000 are all first sides. The display panel 1100 proximate to an edge of the display apparatus 1000 includes a first side 1101 and a second side 1102, and the second side 1102 is proximate to the edge of the display apparatus 1000.

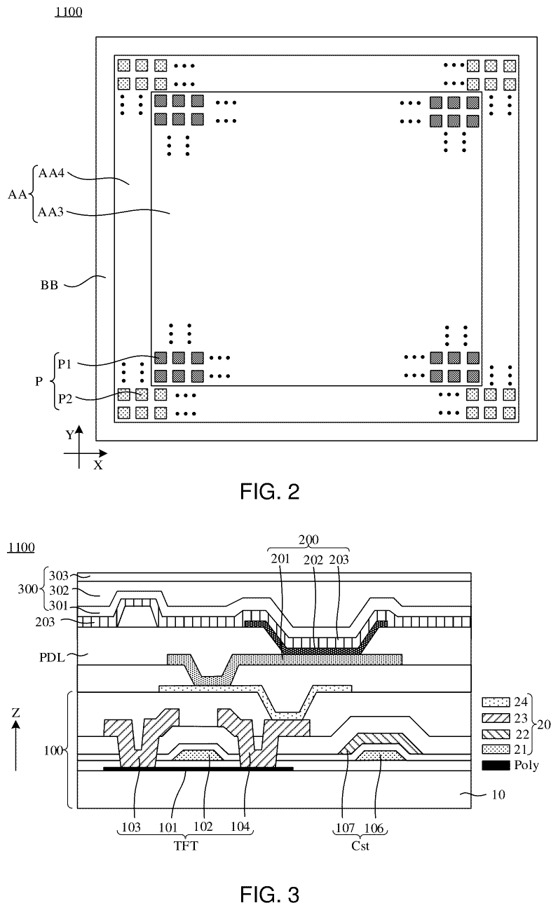

As shown in FIG. 2, FIG. 2 is a plan structural view of a single display panel 1100. The display panel 1100 includes a display area AA and a peripheral area BB. The display area AA is provided with a plurality of sub-pixels P therein. The sub-pixel P is the smallest light-emitting unit in the display panel 1100, and the sub-pixel P is used to display images. The plurality of sub-pixels P are arranged in multiple rows and columns in the display area AA. Each row of sub-pixels P includes sub-pixels P arranged in a first direction X, and the multiple rows of sub-pixels P are arranged in a second direction Y. Each column of sub-pixels P includes sub-pixels P arranged in the second direction Y, and multiple columns of sub-pixels P are arranged in the first direction X.

Referring to FIGS. 1 and 2, the display apparatus 1000 has an overall display area AA′; for the plurality of display panels 1100 of the display apparatus 1000, areas (a third display areas AA3) each in the display area AA away from the seam 1200 is referred to be as a first display area AA1, and an area proximate to the seams 1200 is referred to be as a second display area AA2; the first display area AA1 and the second display area AA2 together constitute the overall display area AA′ of the display apparatus 1000.

For example, at least one sub-pixel P is included between the first display area AA1 and the seam 1200; the second display area AA2 may include the seam 1200, the peripheral area BB of the display panel 1100 proximate to the seam 1200, and at least one row of sub-pixels P or at least one column of sub-pixels P proximate to the first side 1101 (an area of which occupied referred to be as a fourth display area AA4).

The seam 1200 has a certain width, i.e., there is a certain gap between two adjacent display panels 1100, the display panel 1100 has the peripheral area BB, and no sub-pixel P is provided in the peripheral area BB. Therefore, a pixel density of the second display area AA2 is less than a pixel density of the display area AA of the display panel 1100.

In order to prevent the luminance of the second display area AA2 from being less than the luminance of the first display area AA1 in a case where the same gray scale is displayed, an algorithm compensation solution is used in the related art to perform optical algorithm compensation on the overall display area AA′ of the display apparatus 1000, the gray scale of the sub-pixels in different areas may be changed to increase the luminance of the sub-pixels in the second display area AA2, thereby achieving uniform display. However, this solution of algorithmic compensation will reduce the luminance of the sub-pixels P in the first display area AA1, resulting in a small luminance of the entire display apparatus 1000, which is not conducive to improving the display effect of the display apparatus 1000.

In order to solve the above technical problems, referring to FIG. 2, the display panel 1100 provided by the embodiments of the present disclosure includes a plurality of first sub-pixels P1 and a plurality of second sub-pixels P2. That is to say, the plurality of sub-pixels P included in the display panel 1100 may be divided into a plurality of first sub-pixels P1 and second sub-pixels P2.

The plurality of first sub-pixels P1 may be arranged in multiple rows and columns, each row includes first sub-pixels P1 arranged in the first direction X, and the multiple rows of first sub-pixels P1 are arranged in the second direction Y; each column includes first sub-pixels P1 arranged in the second direction Y, and the multiple columns of first sub-pixels P1 are arranged in the first direction X. The plurality of second sub-pixels P2 at least partially surround the plurality of first sub-pixels P1. In the embodiments of the present disclosure, an area where the plurality of first sub-pixels P1 are located is the third display area AA3, an area where the plurality of second sub-pixels P2 are located is the fourth display area AA4, and the fourth display area AA4 at least partially surrounds the third display area AA3.

In some embodiments, the plurality of second sub-pixels P2 surround the plurality of first sub-pixels P1, that is, the fourth display area AA4 surrounds the third display area AA3. Alternatively, the plurality of second sub-pixels P2 are arranged in an extending direction of the first side 1101 of the display panel 1100, that is, the second sub-pixels P2 are only arranged at a position proximate to the first side 1101 of the display panel 1100.

For example, the first sub-pixels P1 are located in the first display area AA1 in the display apparatus 1000, and the second sub-pixels P2 are located in the second display area AA2 in the display apparatus 1000. That is, the plurality of third display areas AA3 of the plurality of display panels 1100 together constitute the first display area AA1 of the display apparatus, the plurality of fourth display areas BB2 of the plurality of display panels 1100, the seams 1200 between the plurality of display panels 1100, and the peripheral areas each between the fourth display area BB2 and the seam 1200 of the plurality of display panels 110 together constitute the second display area AA2.

The plurality of sub-pixels P may emit light of the same color, such as white light or blue light. Based on this, the display panel 1100 further includes a color filter layer provided on a display side, that is, the display panel 1100 adopts color filter on encapsulation (COE) structure. Alternatively, the plurality of sub-pixels P may emit light of different colors. For example, the plurality of sub-pixels P include red sub-pixels that emit red light, green sub-pixels that emit green light, and blue sub-pixels that emit blue light. For example, the plurality of sub-pixels P may be divided into a plurality of pixel units, each pixel unit including a red sub-pixel, a blue sub-pixel and one or two green sub-pixels.

As shown in FIG. 3, in a case where the display panel 1100 is an OLED display panel, the display panel 1100 may include an array substrate 100, a plurality of light-emitting devices 200 and an encapsulation layer 300 that are arranged in sequence. Of course, the display panel 1100 may further include a functional stack layer disposed on a side of the encapsulation layer 300 away from the array substrate 100; the functional stack is, for example, one or more of a touch functional layer, an anti-reflection layer, a hardening layer, or a color filter layer (the display panel adopts the COE structure) and an anti-fingerprint layer, so that the display panel 1100 may achieve the corresponding functions. The type and number of the functional stack layers will not specifically be limited in the embodiments of the present disclosure.

In some embodiments, referring to FIG. 3, the array substrate 100 may include a substrate 10, a semiconductor layer Poly disposed on the substrate 10, and a plurality of conductive layers 20 disposed on a side of the semiconductor layer Poly away from the substrate 10.

As an example, as shown in FIG. 3, the plurality of conductive layers 20 include a first gate conductive layer 21, a second gate conductive layer 22, a first source-drain conductive layer 23 and a second source-drain conductive layer 24 that are sequentially arranged in a direction Z away from the substrate 10, but the embodiments of the present disclosure are not limited thereto. The plurality of conductive layers 20 may further include other film layers. For example, the plurality of conductive layers 20 may include a third gate conductive layer, a third source-drain conductive layer, or other film layers. The display apparatus including any other conductive layer may be considered, as long as the same technical idea is applied. The array substrate 100 may further include an insulating layer disposed between adjacent conductive layers 20, which will not be repeated here.

For example, referring to FIG. 3, the light-emitting device 200 includes an anode 201, a light-emitting functional layer 202, and a cathode layer 203 that are stacked. The display panel 1100 may further include a pixel definition layer PDL. The pixel definition layer PDL is disposed on a side of the anode 201 away from the array substrate 100 and includes a plurality of openings. Each light-emitting device 200 is located in an opening.

The encapsulation layer 300 is configured to reduce the risk of moisture and oxygen in the external environment entering the light-emitting devices 200 to improve the service life of the display panel 1100. The encapsulation layer 300 may be encapsulation film(s) or an encapsulation substrate. For example, as shown in FIG. 3, the encapsulation layer 300 may be an encapsulation film(s); in this case, the encapsulation layers 300 may include a first inorganic encapsulation layer 301, an organic encapsulation layer 302 and a second inorganic encapsulation layer 303 that are stacked in sequence.

Each sub-pixel P includes a pixel circuit and a light-emitting device electrically connected to the pixel circuit. The pixel circuit includes a plurality of thin film transistors (TFTs) and at least one capacitor Cst. For example, the pixel circuit may be a “7T1C” circuit or an “8T1C” circuit; “T” refers to TFT, and the number before “T” refers to the number of TFTs; “C” refers to the capacitor Cst, and the number before “C” refers to the number of capacitors Cst. The thin film transistors may be P-type transistors or N-type transistors. The P-type transistor is turned on due to the action of low level and is turned off due to the action of high level; the N-type transistor is turned on due to the action of high level and is turned off due to the action of low level.

As shown in FIG. 3, the TFT may include a semiconductor pattern 101 located in the semiconductor layer Poly, a gate 102 located in the first gate conductive layer 21, a source 103 and a drain 104 located in the first source-drain conductive layer 23. The capacitor Cst may include a first plate 106 located in the first gate conductive layer 21 and a second plate 107 located in the second gate conductive layer 22, and an orthographic projection of the first plate 106 on the substrate 10 at least partially coincide with an orthographic projection of the second plate 107 on the substrate 10.

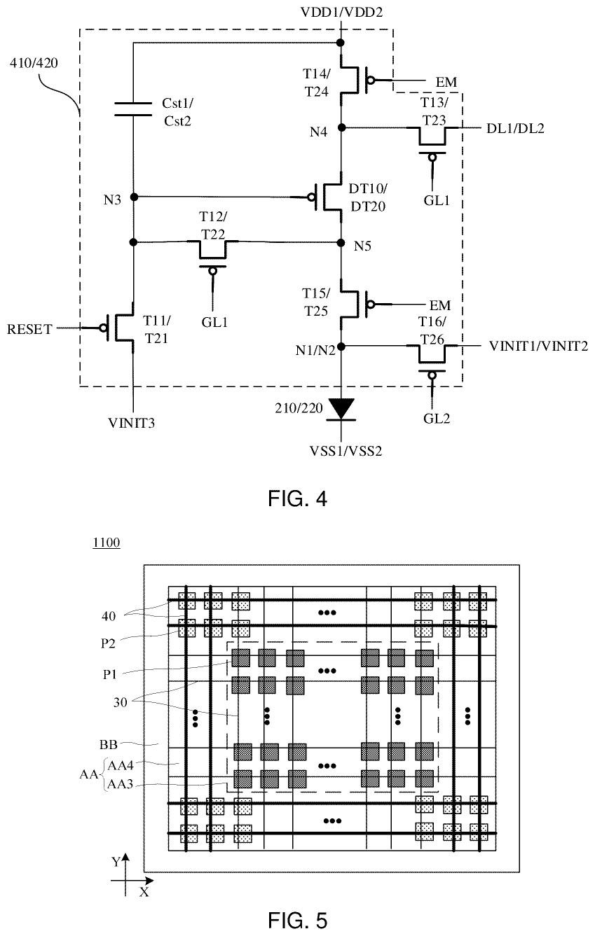

In the following embodiments of the present disclosure, as shown in FIG. 4, considering an example in which the pixel circuit is a “7T1C” circuit and the thin film transistors included in the pixel circuit are P-type transistors for schematic description, but the embodiments of the present disclosure do not limit thereto; any other pixel circuit may also be considered, as long as the same technical idea is applied.

Considering the first sub-pixel P1 as an example, the first sub-pixel P1 includes a first pixel circuit 410, as shown in FIG. 4, the first pixel circuit 410 includes a first driving transistor DT10, a third rest transistor T11, a compensation transistor T12, a data writing transistor T13, a first light-emitting control transistor T14, a second light-emitting control transistor T15, a first reset transistor T16, and a first capacitor Cst1. A gate of the first driving transistor DT10 is electrically connected to a third node N3, a source of the first driving transistor DT10 is electrically connected to a fourth node N4, and a drain of the first driving transistor DT10 is electrically connected to a fifth node N5.

A gate of the third transistor T11 is electrically connected to a reset signal line Reset, a source of the third transistor T11 is electrically connected to a third initial voltage signal line VINIT3, and a drain of the third transistor T11 is electrically connected to the third node N3. A gate of the compensation transistor T12 is electrically connected to a first scanning signal line GL1, a source of the compensation transistor T12 is electrically connected to the fifth node N5, and a drain of the compensation transistor T12 is electrically connected to the third node N3. A gate of the data writing transistor T13 is electrically connected to the first scanning signal line GL1, a source of the data writing transistor T13 is electrically connected to a first data signal line DL1, and a drain of the data writing transistor T13 is electrically connected to the fourth node N4. A gate of the first light-emitting control transistor T14 is electrically connected to a light-emitting control signal line EM, a source of the first light-emitting control transistor T14 is electrically connected to a first positive voltage signal line VDD1, and a drain of the first light-emitting control transistor T14 is electrically connected to the fourth node N4. A gate of the second light-emitting control transistor T15 is electrically connected to the light-emitting control signal line EM, a source of the second light-emitting control transistor T15 is electrically connected to the fifth node N5, and a drain of the second light-emitting control transistor T15 is electrically connected to a first node N1. The first node N1 is further used to be electrically connected to a first light-emitting device 210. A gate of the first reset transistor T16 is electrically connected to a second scanning signal line GL2, a source of the first reset transistor T16 is electrically connected to a first initial voltage signal terminal VINIT1, and a drain of the first reset transistor T16 is electrically connected to the first node N1. One plate of the first capacitor Cst1 is electrically connected to the first positive voltage signal line VDD1, and the other plate is electrically connected to the third node N3.

It will be understood that the second sub-pixel P2 includes a second pixel circuit 420, and the second pixel circuit 420 includes a second driving transistor DT20, a third reset transistor T21, a compensation transistor T22, a data writing transistor T23, a first light-emitting control transistor T24, a second light-emitting control transistor T25, a second reset transistor T26 and a second capacitor Cst2. The structure and connection relationship of the second pixel circuit 420 are similar to those of the first pixel circuit 410, and will not be repeated here.

FIG. 5 is a structural diagram of a display panel including first signal lines 30 and second signal lines 40. Referring to FIG. 5, the display panel 1100 further includes first signal lines 30 and second signal lines 40. The first signal line 30 is electrically connected to the first sub-pixels P1, and the first signal line 30 is configured to transmit at least one of a first positive voltage signal, a first negative voltage signal, a first initial voltage signal and a data signal to the first sub-pixel P1. The second signal line 40 is electrically connected to the second sub-pixels P2, and the second signal line 40 is configured to transmit at least one of a second positive voltage signal, a second negative voltage signal, a second initial voltage signal and a data signal to the second sub-pixels P2.

It will be understood that in FIG. 5, the first signal line 30 is represented by a thin solid line, and the second signal line 40 is represented by a thick solid line. The first signal line 30 and the second signal line 40 are insulated from each other, so that the first signal line 30 and the second signal line 40 may transmit different voltage signals.

In the case where the same gray scale is displayed, the luminance of the first sub-pixel P1 is less than the luminance of the second sub-pixel P2. In other words, in the case where the same gray scale is displayed, the first sub-pixel P1 displays a first luminance under control of the first signal line 30, the second sub-pixel P2 displays a second luminance under control of the second signal line 40, and the first luminance is less than the second luminance. By increasing the luminance of the second sub-pixel P2, it may be possible to increase the overall luminance of the second display area AA2 in the display apparatus 1000, which reduces the luminance difference between the second display area AA2 and the first display area AA1, thereby improving the uniformity of the luminance of the entire display area of the display apparatus 1000. Moreover, it is conducive to improving the maximum luminance of the first display area AA1, which increases the maximum luminance of the first sub-pixels P1, thereby improving the display effect of the display apparatus 1000.

It will be understood that the first signal lines 30 may include a plurality of signal lines. For example, the first signal lines 30 may include at least one of the first positive voltage signal line VDD1, a first negative voltage signal line VSS1, a first data line DL1 and a first initial voltage signal line VINIT1. Similarly, the second signal lines 40 may include a plurality of signal lines. For example, the second signal line 40 may include at least one of the second positive voltage signal line VDD2, a second negative voltage signal line VSS2, the second data line DL2 and the second initial voltage signal line VINIT2.

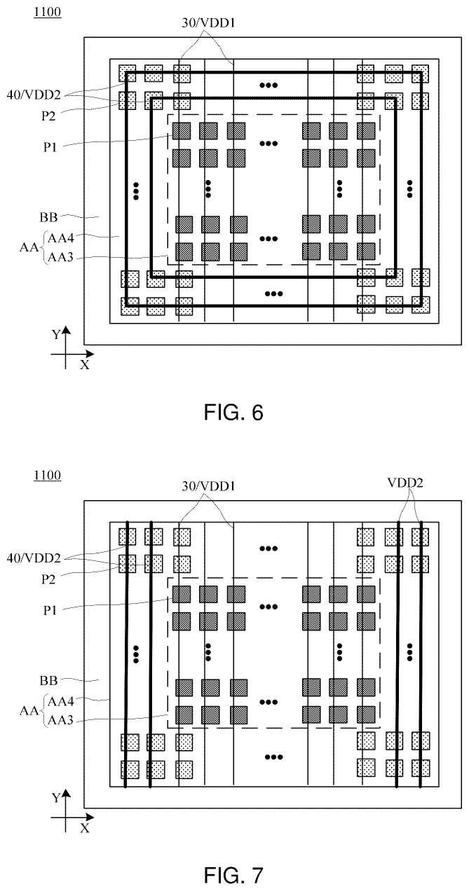

In some embodiments, referring to FIG. 6, FIG. 6 is a structural diagram of the display panel 1100 including first positive voltage signal lines VDD1 and second positive voltage signal lines VDD2.

The first signal lines 30 include the first positive voltage signal lines VDD1, and the first positive voltage signal line VDD1 is configured to transmit the first positive voltage signal. The first positive voltage signal may also be referred to be as a first operating voltage signal or a first power supply signal. The first positive voltage signal line VDD1 is electrically connected to the pixel circuit of the first sub-pixel P1.

The second signal lines 40 include the second positive voltage signal line(s) VDD2; the second positive voltage signal line VDD2 is configured to transmit the second positive voltage signal, and the second positive voltage signal line VDD2 is electrically connected to the pixel circuit of the second sub-pixel P2.

As shown in FIG. 4, the first positive voltage signal line VDD1 is electrically connected to the source of the first light-emitting control transistor T14, and is used to transmit the first positive voltage signal to the source of the first driving transistor DT10 when the first light-emitting control transistor T14 is turned on. The driving current of the first driving transistor DT10 is positively related to the voltage value of the first positive voltage signal. The luminance of the light-emitting device 200 is positively related to the current flowing through the light-emitting device. The voltage value of the first positive voltage signal is less than the voltage value of the second positive voltage signal. In a case where the first data signal and the second data signal are the same (displaying the same gray scale), the driving current of the first driving transistor DT10 is less than the driving current of the second driving transistor DT20. The luminance of the second sub-pixel P2 is greater than the luminance of the first sub-pixel P1, which is beneficial to improving the uniformity of the luminance of the overall display area AA′ of the display apparatus 1000 and improving the display effect of the display apparatus 1000.

In some embodiments, as shown in FIG. 6, in a case where the plurality of second sub-pixels P2 surround the plurality of first sub-pixels P1, the second positive voltage signal lines VDD2 may each extend along a peripheral edge of the plurality of first sub-pixels P1. That is, the second positive voltage signal line VDD2 may extend in an arrangement direction of the second sub-pixels P2 to be in a shape of an annulus, or the second positive voltage signal line VDD2 may extend in an extending direction of the fourth display area AA4 to be in a shape of an annulus. The second positive voltage signal lines VDD2 are electrically connected to the plurality of second sub-pixels P2 (all the second sub-pixels P2). In this way, it is beneficial for the second positive voltage signal line VDD2 to be electrically connected to the second sub-pixels P2, so that the second positive voltage signals received by all the second sub-pixels P2 have the same magnitude.

As shown in FIG. 6, the display panel 1100 includes a plurality of first positive voltage signal lines VDD1 spaced apart in the first direction X, each first positive voltage signal line VDD1 substantially extends in the second direction Y, and each first positive voltage signal line VDD1 is electrically connected to a column of first sub-pixels P1.

The first positive voltage signal line VDD1 and the second positive voltage signal line VDD2 are located in different conductive layers 20, so as to avoid signal interference between the first positive voltage signal lines VDD1 and the second positive voltage signal lines VDD2, and to increase the wiring space of the first positive voltage signal lines VDD1 and the second positive voltage signal lines VDD2.

Of course, in a case where the first positive voltage signal lines VDD1 and the second positive voltage signal line(s) VDD2 are located in different conductive layers 20, the display panel 1100 may include a plurality of second positive voltage signal lines VDD2 spaced apart in the first direction X, and each second positive voltage signal line VDD2 is electrically connected to the second sub-pixels P2 in a column.

In some other embodiments, referring to FIG. 7, at least part of the plurality of second sub-pixels P2 are arranged in a plurality of columns, and at least one column of second sub-pixels P2 is arranged on each of both sides, in the first direction X, of the plurality of first sub-pixels P1. A column of second sub-pixels P2 includes second sub-pixels P2 arranged in the second direction Y. The first direction X intersects the second direction Y; for example, the first direction X and the second direction Y are perpendicular to each other.

The display panel 1100 includes a plurality of second positive voltage signal lines VDD2, and each second positive voltage signal line VDD2 is electrically connected to a column of second sub-pixels P2. That is, the second positive voltage signal lines VDD2 may be only electrically connected to the second sub-pixels P2 on both sides of the plurality of first sub-pixels P1 in the first direction X. Based on this, the second positive voltage signal lines VDD2 and the first positive voltage signal lines VDD1 may be located in the same conductive layer. In this way, it is beneficial to reducing the number of conductive layers 20 of the display panel 1100, so as to reduce the manufacturing cost of the display panel 1100, and reduce the thickness of the display panel 1100.

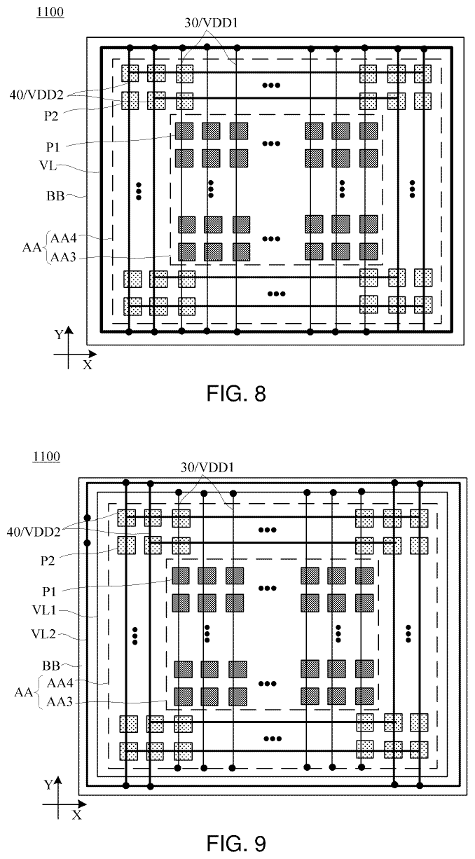

In some other embodiments, refer to FIG. 8, FIG. 8 being a structural diagram of the display panel 1100 including a positive voltage signal bus VL, the display panel 1100 further includes a positive voltage signal bus VL; the positive voltage signal bus VL is arranged in the peripheral area BB, and the positive voltage signal bus VL surrounds the display area AA. The first positive voltage signal lines VDD1 and the second positive voltage signal line(s) VDD2 are all electrically connected to the positive voltage signal bus VL, and a line width of the first positive voltage signal line VDD1 is less than a line width of the second positive voltage signal line VDD2, so that the resistance of the second positive voltage signal line VDD2 is less than the resistance of the first positive voltage signal line VDD1, and the voltage drop of the second positive voltage signal on the second positive voltage signal line VDD2 is less than the voltage drop of the first positive voltage signal on the first positive voltage signal line VDD1. As a result, it is possible to achieve that the voltage value of the second positive voltage signal is greater than the voltage value of the first positive voltage signal. In this way, it is beneficial to reducing the number of wirings in the peripheral area BB and reducing the width of the peripheral area BB to reduce the width of the seam 1200, thereby improving the display effect of the display apparatus.

In some other embodiments, referring to FIG. 9, FIG. 9 being a structural diagram of a display panel including a first positive voltage signal bus VL1 and a second positive voltage signal bus VL2, the display panel 1100 further includes a first positive voltage signal bus VL1 and a second positive voltage signal bus VL2. The first positive voltage signal bus VL1 is arranged in the peripheral area BB, and the first positive voltage signal bus VL1 is arranged around the display area AA; the first positive voltage signal bus VL1 is configured to transmit the first positive voltage signal. The second positive voltage signal bus VL2 is arranged in the peripheral area BB, and the second positive voltage signal bus VL2 is arranged around the display area AA and is configured to transmit the second positive voltage signal. The first positive voltage signal bus VL1 is electrically insulated from the second positive voltage signal bus VL2, and the voltage value of the second positive voltage signal is greater than the voltage value of the first positive voltage signal.

The first positive voltage signal lines VDD1 are electrically connected to the first positive voltage signal bus VL1, and the second positive voltage signal lines VDD2 are electrically connected to the second positive voltage signal bus VL2. That is, the first positive voltage signal lines VDD1 and the second positive voltage signal lines VDD2 perform signal transmission through two different buses respectively, which is beneficial to improving the stability and stability of the second positive voltage signal and the first positive voltage signal.

In some embodiments, as shown in FIG. 4, the first sub-pixel P1 includes a first pixel circuit 410 and a first light-emitting device 210; the first pixel circuit includes a first node N1, and the first node N1 is electrically connected to the first light-emitting device 210. The second sub-pixel P2 includes a second pixel circuit 420 and a second light-emitting device 220; the second pixel circuit 420 includes a second node N2, and the second node N2 is electrically connected to the second light-emitting device 220.

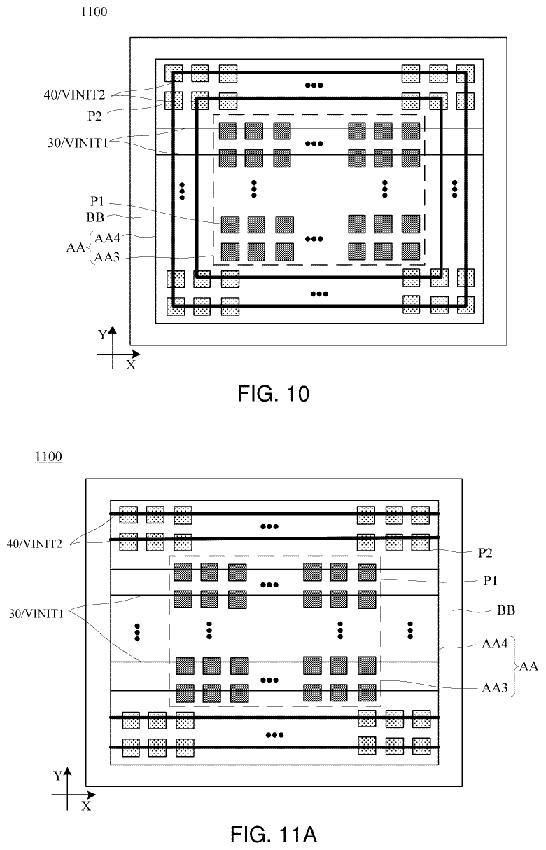

In some embodiments, referring to FIG. 10, FIG. 10 being a structural diagram of a display panel 1100 including a first initial voltage signal line VINIT1 and a second initial voltage signal line VINIT2, the first signal lines 30 further include first initial voltage signal lines VINIT1. The first initial voltage signal line VINIT1 is configured to transmit a first initial voltage signal and is configured to initialize the first node N1. The second signal lines 40 further include second initial voltage signal lines VINIT2. The second initial voltage signal line VINIT2 is configured to transmit a second initial voltage signal and is configured to initialize the second node N2.

The inventors found through research that the less the initial voltage value of the first node N1 (or the second node N2), the greater the driving current generated by the pixel circuit. The voltage value of the first initial voltage signal is greater than the voltage value of the second initial voltage signal. Based on this, it is beneficial to increasing the driving current of the second pixel circuit 420 (compared with the driving current of the first pixel circuit 410) to increase the luminance of the second light-emitting device 220, which is beneficial to increasing the overall luminance of the second display area AA2 in the display apparatus 1000 and reduce the luminance difference between the second display area AA2 and the first display area AA1, thereby improving the uniformity of the luminance of the entire display area of the display apparatus 1000; moreover, it is beneficial to increasing the maximum luminance of the first display area AA1, which further increases the maximum luminance of the first sub-pixel P1, thereby improving the display effect of the display apparatus 1000.

Referring to FIG. 10, the plurality of second sub-pixels P2 surround the plurality of first sub-pixels P1. The second initial voltage signal lines VINIT2 each extend along a peripheral edge of the plurality of first sub-pixels P1 and are electrically connected to the plurality of second sub-pixels P2 (all the second sub-pixels P2). That is, the second initial voltage signal line VINIT2 may extend in an arrangement direction of the second sub-pixels P2 to be in a shape of an annulus, or the second initial voltage signal line VINIT2 may extend in an extending direction of the fourth display area AA4 to be in a shape of an annulus. The second initial voltage signal lines VINIT2 are electrically connected to the plurality of second sub-pixels P2 (all the second sub-pixels P2). In this way, it is beneficial for the second initial voltage signal line VINIT2 to be electrically connected to all the second sub-pixels P2, so that the voltage values of the second initial voltage signals received by all the second sub-pixels P2 are the same.

As shown in FIG. 10, the display panel 1100 further includes a plurality of first initial voltage signal lines VINIT1 spaced apart in the second direction Y. Each first initial voltage signal line VINIT1 substantially extends in the first direction X, and each first initial voltage signal line VINIT1 is electrically connected to a row of first sub-pixels P1.

The display panel 1100 includes a plurality of conductive layers 20, and the first initial voltage signal lines VINIT1 and the second initial voltage signal lines VINIT2 are located in different conductive layers, so as to avoid signal interference between the first initial voltage signal line VINIT1 and the second initial voltage signal line VINIT2, and to increase the wiring space of the first initial voltage signal line VINIT1 and the second initial voltage signal line VINIT2.

Of course, in a case where the first initial voltage signal lines VINIT1 and the second initial voltage signal lines VINIT2 are located in different conductive layers 20, the display panel 1100 may also include a plurality of second initial voltage signal lines VINIT2 spaced apart in the second direction Y, and each second initial voltage signal line VINIT2 is electrically connected to the second sub-pixels P2 located in a row (not shown in the figure).

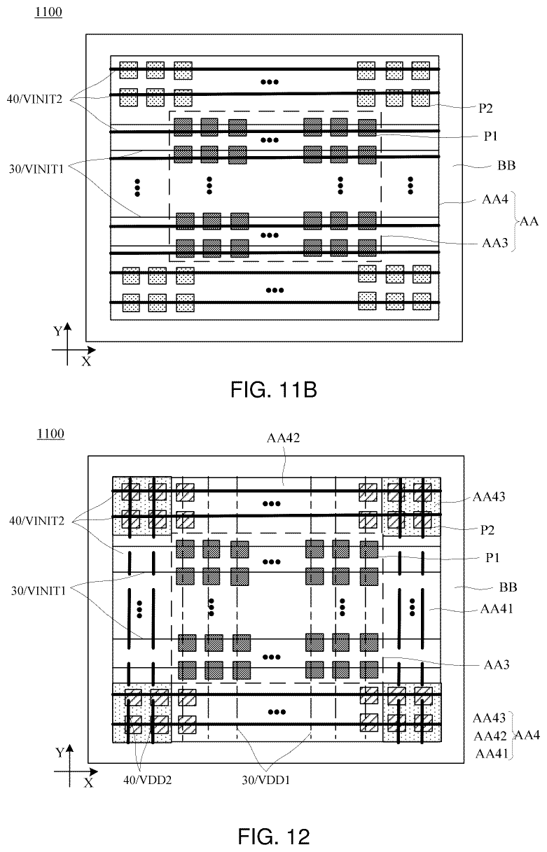

In some other embodiments, referring to FIG. 11A, FIG. 11A being a structural diagram of the second initial voltage signal line VINIT2 extending in the first direction X, at least part of the plurality of second sub-pixels P2 are arranged in a plurality of rows, and at least one row of second sub-pixels P2 is arranged on each of both sides, in the second direction Y, of the plurality of first sub-pixels P1; that is, at least one row of second sub-pixels P2 is arranged on each of both sides, in the second direction Y, of the third display area AA3.

The display panel 100 includes a plurality of second initial voltage signal lines VINIT2, and each second initial voltage signal line VINIT2 is electrically connected to a row of second sub-pixels P2. That is, the second initial voltage signal lines VINIT2 may be only electrically connected to the second sub-pixels P2 on both sides of the plurality of first sub-pixels P1 in the first direction X. Based on this, the second initial voltage signal lines VINIT2 and the first initial voltage signal lines VINIT1 may be located in the same conductive layer. In this way, it is beneficial to reducing the number of conductive layers 20 of the display panel 1100, so as to reduce the manufacturing cost of the display panel 1100, and reduce the thickness of the display panel 1100.

It will be understood that, as shown in FIG. 11B, in a case where the second initial voltage signal lines VINIT2 and the first initial voltage signal lines VINIT1 are located in different conductive layers, the second initial voltage signal line VINIT2 may also extend in the first direction X, and each second initial voltage signal line VINIT2 is electrically connected to the second sub-pixels P2 located in a row.

In some embodiments, the display panel 1100 includes an initial voltage signal bus, the first initial voltage signal lines VINIT1 and the second initial voltage signal lines VINIT2 are both electrically connected to the initial voltage signal bus, and the line width of the first initial voltage signal line VINIT1 is less than the line width of the second initial voltage signal line VINIT2. Alternatively, the display panel 1100 includes a first initial voltage signal bus and a second initial voltage signal bus, the first initial voltage signal bus is used to transmit the first initial voltage signal, and the second initial voltage signal bus is used to transmit the second initial voltage signal. The first initial voltage signal lines VINIT1 are electrically connected to the first initial voltage signal bus, and the second initial voltage signal lines VINIT2 are electrically connected to the second initial voltage signal bus.

In an embodiment, as shown in FIG. 12, the plurality of second sub-pixels P2 are arranged in a plurality of rows and a plurality of columns; at least one column of second sub-pixels P2 is arranged on each of both sides, in the first direction X, of the plurality of first sub-pixels P1 (or the third display area AA3), and at least one row of second sub-pixels P2 is arranged on each of both sides, in the second direction Y, of the plurality of first sub-pixels P1 (or the third display area AA3). The display panel 1100 includes a plurality of second positive voltage signal lines VDD2 and a plurality of second initial voltage signal lines VINIT2; each second positive voltage signal line VDD2 is electrically connected to a column of second sub-pixels P2, and each second initial voltage signal line VINIT2 is electrically connected to a row of second sub-pixels P2.

As shown in FIG. 12, the fourth display area AA4 may be divided into two first sub-regions AA41, two second sub-regions AA42 and four third sub-regions AA43. The two first sub-regions AA41 are respectively located on both sides of the third display area AA3 in the first direction X, the two second sub-regions AA42 are respectively located on both sides of the third display area AA3 in the second direction Y, and the four third sub-regions AA43 are located at four corners of the fourth display area AA4. The second sub-pixels P2 in the two first sub-regions AA41 are each electrically connected to the second voltage signal line VDD2 and the first initial voltage signal line VINIT1. The second sub-pixels P2 in the two second sub-regions AA42 are each electrically connected to the first voltage signal line VDD1 and the second initial voltage signal line VINIT2. The second sub-pixels P2 in the four third sub-regions AA43 are each electrically connected to the second positive voltage signal line VDD2 and the second initial voltage signal line VINIT2. In this way, it is possible to reduce the number of conductive layers 20 to the greatest extent, so that the thickness and manufacturing cost of the display panel 1100 may be reduced.

Of course, it will be understood that the above-mentioned embodiments of the present disclosure may be combined in other forms. For example, all the second sub-pixels P2 are each electrically connected to the second positive voltage signal line VDD2 and the second initial voltage signal line VINIT2, and the embodiments of the present disclosure are not limited thereto, as long as the same technical ideas are applied in the present disclosure.

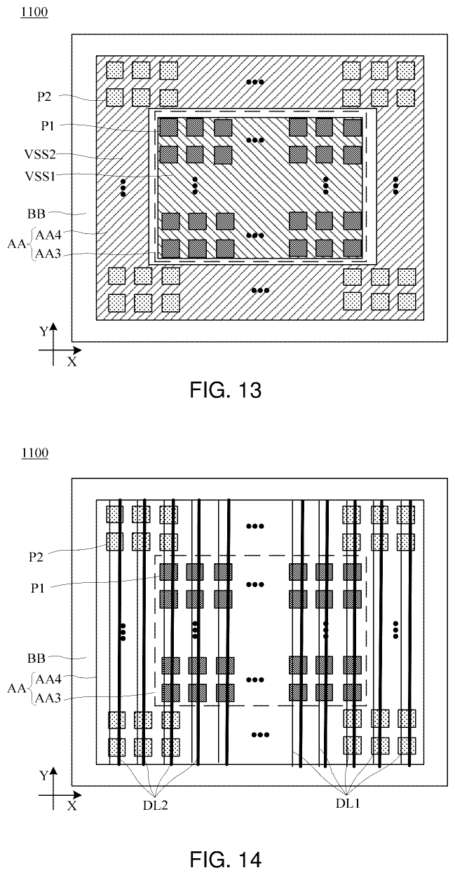

In some embodiments, referring to FIG. 13, the first signal lines 30 further includes a first negative voltage signal line VSS1, and the first negative voltage signal line VSS1 is configured to transmit the first negative voltage signal and is configured to be electrically connected to the cathode of the light-emitting device 210. The second signal lines 40 further includes a second negative voltage signal line VSS2, and the second negative voltage signal line VSS2 is configured to transmit the second negative voltage signal and is configured to be electrically connected to the cathode of the second light-emitting device 220. The current of the light-emitting device 200 is negatively related to the voltage value of the cathode. That is, the less the voltage of the cathode of the light-emitting device 200 is, the greater the current of the light-emitting device 200 is, and the higher the luminance of the light-emitting device 200 is. Based on this, the voltage value of the first negative voltage signal is greater than the voltage value of the second negative voltage signal. Thus, it is beneficial to increasing the luminance of the second light-emitting device 220 to increase the overall luminance of the second display area AA2 of the display apparatus 1000, which may reduce the luminance difference between the second display area AA2 and the first display area AA1, thereby improving the uniformity of the luminance of the overall display area of the display apparatus 1000; moreover, it is beneficial to improving the maximum luminance of the first display area AA1, which increases the maximum luminance of the first sub-pixel P1, thereby improving the display effect of the display apparatus 1000.

In some embodiments, as shown in FIG. 13, the first negative voltage signal line VSS1 and the second negative voltage signal line VSS2 are arranged in the same layer, and the first negative voltage signal line VSS1 and the second negative voltage signal line VSS2 have a gap therebetween. For example, as shown in FIG. 13, the second negative voltage signal line VSS2 may be disposed around the first negative voltage signal line VSS1.

In some embodiments, the display panel 1100 includes a first negative voltage signal bus and a second negative voltage signal bus. The first negative voltage signal bus is used to transmit the first negative voltage signal, and the second negative voltage signal bus is used to transmit the second negative voltage signal. The first negative voltage signal line VSS1 is electrically connected to the first negative voltage signal bus, and the second negative voltage signal line VSS2 is electrically connected to the second negative voltage signal bus.

It will be understood that the first negative voltage signal line VSS1 and the second negative voltage signal line VSS2 may be electrically connected to the first negative voltage signal bus and the second negative voltage signal bus in the peripheral area BB through cross lines provided in other conductive layers.

As shown in FIG. 14, in some embodiments, the first signal lines 30 include first data signal lines DL1, and the second signal lines 40 include second data signal lines DL2. A resistance of the first data signal line DL1 is less than a resistance of the second data signal line DL2. The luminance formula of sub-pixel P in the OLED panel is as follows.

Lum∝½×μ×Cox×W/L×(V_{data}−Vₜₕ)\hat{2} (1)

In the above formula (1), “Lum” is the luminance of the light-emitting device, “Cox” is the capacitance of the capacitor in the pixel circuit, “W/L” is the width-to-length ratio of the channel structure of the driving transistor, and “Vdata” is the voltage value of the data signal. It can be seen from the formula (1) that the luminance of the light-emitting device is negatively related to the voltage value of the data signal. That is, the smaller V_{data} is, the greater the difference of (V_{data}−Vₜₕ) is, and the greater the luminance of the light-emitting device is.

Based on the above description, in the embodiments of the present disclosure, the resistance of the first data signal line DL1 is less than the resistance of the second data signal line DL2, which is beneficial to reduce the voltage value of the data signal transmitted by the second data signal line DL. That is, in a case where the driver chip sends the same data signal, the voltage value of the data signal transmitted to the second sub-pixel P2 through the second data signal line DL2 is less than the voltage value of the data signal transmitted to the first sub-pixel P1 through the first data signal line DL1. In this way, the second sub-pixel P2 may display a higher luminance than the first sub-pixel P1, which increases the overall luminance of the second display area AA2 of the display apparatus 1000, so that the luminance difference between the second display area AA2 and the first display area AA1 is reduced to improve the uniformity of the luminance of the overall display area of the display apparatus 1000; moreover, it is beneficial to increasing the maximum luminance of the first display area AA1, which increases the maximum luminance of the first sub-pixel P1, so that the display effect of the display apparatus 1000 is improved.

Referring to FIG. 14, in the case where the plurality of second sub-pixels P2 surround the plurality of first sub-pixels P1, and all the second sub-pixels P2 are electrically connected to the second data signal lines DL2, the first data signal lines DL1 and the second data signal lines DL2 may be located in different conductive layers, so as to avoid signal interference between the first data signal lines DL1 and the second data signal lines DL2 and increase the wiring space of the first data signal lines DL1 and the second data signal lines DL2. A resistivity of a material of the first data signal lines is less than a resistivity of a material of the second data signal lines, so that the resistance of the first data signal line DL1 is less than the resistance of the second data signal line DL2. For example, the material of the first data lines DL1 may be metal materials such as copper or copper alloy; the material of the second data lines DL2 may be indium tin oxides (ITO).

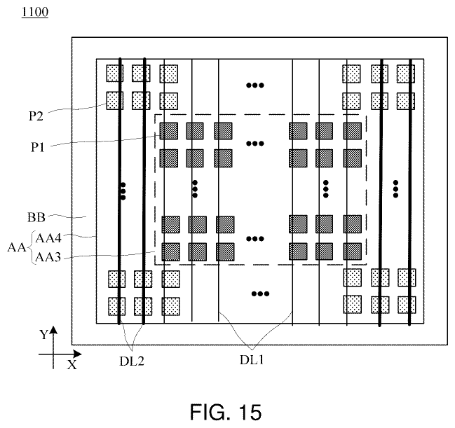

In some other embodiments, as shown in FIG. 15, at least part of the plurality of second sub-pixels P2 is arranged in a plurality of columns, and the plurality of first sub-pixels P1 are provided, on each of both side in the first direction X, with at least one column of second sub-pixels. A column of second sub-pixels P2 includes second sub-pixels P2 arranged in the second direction Y.

Each second data line DL2 is electrically connected to a column of second sub-pixels P2. That is, the second data lines DL2 are only electrically connected to the second sub-pixels P2 on both sides of the third display area AA3 in the first direction X. In this case, the first data signal lines DL1 and the second data signal lines DL2 may be located in the same conductive layer, and a line width of the first data signal line DL1 is greater than a line width of the second data signal line DL2. In this way, it is beneficial to reducing the number of conductive layers 20 of the display panel 1100, thereby reducing the manufacturing cost of the display panel 1100 and reducing the thickness of the display panel 1100. Moreover, the line width of the first data signal line DL1 is greater than the line width of the second data signal line DL2, so that the resistance of the first data signal line DL1 is less than the resistance of the second data signal line DL2. Thus, in a case where the first sub-pixel P1 and the second sub-pixel P2 display the same gray scale, the luminance of the first sub-pixel P1 is less than the luminance of the second sub-pixel P2.

In some embodiments, the first sub-pixel P1 includes a first driving transistor DT10 and a first capacitor Cst1; a plate of the first capacitor Cst1 is electrically connected to a gate of the first driving transistor DF1. The second sub-pixel P2 includes a second driving transistor DT20 and a second capacitor Cst2; a plate of the second capacitor Cst2 is electrically connected to a gate of the second driving transistor DT20. It can be seen from the above formula (1) that the luminance of the light-emitting device 200 is also positively related to the capacitance of the capacitor Cst. The greater the capacitance of the capacitor Cst, the more charges are stored on the plate of the capacitor, the more stable the voltage of the capacitor, and the more stable the sub-pixel emits light. Based on this, the capacitance of the second capacitor Cst2 is greater than the capacitance of the first capacitor Cst1, it is beneficial to improving the luminance of the second sub-pixel P2, which increases the overall luminance of the second display area AA2 of the display apparatus 1000, so that the luminance difference between the second display area AA2 and the first display area AA1 is reduced and the uniformity of the luminance of the overall display area of the display apparatus 1000 is improved; moreover, it is conducive to increasing the maximum luminance of the first display area AA1, which increases the maximum luminescence of the first sub-pixel P1 to improve the display effect of the display apparatus 1000.

In some embodiments, a facing area between at least two plates included in the second capacitor Cst2 is greater than a facing area between at least two plates included in the first capacitor Cst1. In this way, the capacitance of the second capacitor Cst2 is greater than the capacitance of the first capacitor Cst1, which is beneficial to reducing the number of conductive layers 20 of the display panel 1100, and reducing the thickness and manufacturing cost of the display panel 1100.

In some other embodiments, the number of plates included in the second capacitor Cst2 is greater than the number of plates included in the first capacitor Cst1. In this way, the capacitance of the second capacitor Cst2 may be greater than the capacitance of the first capacitor Cst1, and the area of the second capacitor Cst2 is reduced, which is beneficial to improving the pixel density of the second sub-pixel P2.

In some embodiments, the first sub-pixel P1 includes a first driving transistor DT10, and the second sub-pixel P2 includes a second driving transistor DT20. A width-to-length ratio of a channel structure of the first driving transistor DT10 is less than a width-to-length ratio of a channel structure of the second driving transistor DT20. It can be seen from the above formula (1) that the luminance of the sub-pixel P is positively related to the width-to-length ratio of the channel structure of the driving transistor. Compared to the first sub-pixel P1, by increasing the width-to-length ratio of the channel structure of the second driving transistor DT20 of the second sub-pixel P2, the display luminance of the second sub-pixel P2 may be increased, which may increase the overall luminance of the second display area AA2 of the display apparatus 1000, and reduce the luminance difference between the second display area AA2 and the first display area AA1, so that the uniformity of the luminance of the overall display area of the display apparatus 1000 may be improved. Moreover, it is conducive to increasing the maximum luminance of the first display area AA1, which increases the maximum luminance of the first sub-pixel P1, thereby improving the display effect of the display apparatus 1000.

For example, the width-to-length ratio of the channel structure of the second driving transistor DT20 may be increased by increasing the width of the channel structure of the second driving transistor DT20 or reducing the length of the channel structure of the second driving transistor DT20.

In some embodiments, the display panel 1100 has a display area AA and a bonding region located on a side of the display area AA. The bonding area is provided with connection pins and dummy pins. The first signal lines 30 are electrically connected to the connection pins, and the second signal lines 40 are electrically connected to the connection pins and/or the dummy pins.

For example, in a case where the display panel 1100 includes the positive voltage signal bus VL, and the first positive voltage signal lines VDD1 and the second positive voltage signal lines VDD2 are all electrically connected to the positive voltage signal bus VL, the second positive voltage signal lines VDD2 of the second signal lines 40 are electrically connected to the connection pins through the positive voltage signal bus VL. In a case where the display panel further includes the first positive voltage signal bus VL1 and the second positive voltage signal bus VL2, the second positive voltage signal lines VDD2 of the second signal lines 40 are electrically connected to the dummy pins through the second positive voltage signal bus VL2. Similarly, both the second initial voltage signal lines VINIT2 and the second negative voltage signal line VSS2 of the second signal lines 40 may be electrically connected to the connection pins or the dummy pins.

It will be understood that the display apparatus 1000 includes a driver chip. The driver chip is provided with a plurality of pins for transmitting control signals and power signals and a plurality of dummy pins. The dummy pins refer to pins on the original driver chip and not used for transmitting signals. In the solution provided in the embodiments of the present application, various voltage signals (e.g., the first positive voltage signal and the second positive voltage signal) may be generated through the dummy pins, which is conducive to simplifying the control difficulty of the display apparatus, thereby reducing the cost of display apparatus.

The above are only specific embodiments of the present disclosure, but the scope of protection of the present disclosure is not limited thereto, and any person skilled in the art may conceive of variations or replacements within the technical scope of the present disclosure, which shall fall within the protection scope of the present disclosure. Therefore, the protection scope of the present disclosure shall be determined by the protection scope of the claims.

1. A display panel, comprising:
a plurality of first sub-pixels and a plurality of second sub-pixels, the plurality of second sub-pixels at least partially surrounding the plurality of first sub-pixels;
first signal lines electrically connected to the first sub-pixels and configured to transmit at least one of a first positive voltage signal, a first negative voltage signal, a first initial voltage signal and a data signal to the first sub-pixels; and
second signal lines electrically connected to at least part of the plurality of second sub-pixels and configured to transmit at least one of a second positive voltage signal, a second negative voltage signal, a second initial voltage signal and another data signal to the at least part of the plurality of second sub-pixels;
wherein a first sub pixel and a second sub pixel display a same gray scale, a luminance of the first sub-pixel is less than a luminance of the second sub-pixel.

2. The display panel according to claim 1, wherein
the first signal lines include first positive voltage signal lines, a first positive voltage signal line is configured to transmit the first positive voltage signal; and
the second signal lines include at least one second positive voltage signal line, a second positive voltage signal line is configured to transmit the second positive voltage signal;
wherein a voltage value of the first positive voltage signal is less than a voltage value of the second positive voltage signal.

3. The display panel according to claim 2, wherein
the plurality of second sub-pixels surround the plurality of first sub-pixels;
the at least one second positive voltage signal line each extends a peripheral edge of the plurality of first sub-pixels and the at least one second positive voltage signal line is electrically connected to the second sub-pixels;
the display panel comprises a plurality of conductive layers, and the first positive voltage signal lines and the at least one second positive voltage signal line are located in different conductive layers.

4. The display panel according to claim 2, wherein
the at least part of the plurality of second sub-pixels are arranged in a plurality of columns, and at least one column of second sub-pixels is arranged on each of both sides, in a first direction, of the plurality of first sub-pixels; a column of second sub-pixels includes second sub-pixels arranged in a second direction; the first direction and the second direction intersect;
the display panel comprises a plurality of second positive voltage signal lines, wherein each second positive voltage signal line is electrically connected to a respective column of second sub-pixels; and
the display panel comprises a plurality of conductive layers, wherein the first positive voltage signal lines and the second positive voltage signal lines are arranged in a same layer.

5. The display panel according to claim 3, wherein the display panel has a display area and a peripheral area, and the plurality of first sub-pixels and the plurality of second sub-pixels are located in the display area; the peripheral area surrounds the display area;
the display panel further comprises:
a positive voltage signal bus arranged in the peripheral area and surrounding the display area; wherein the first positive voltage signal lines and the at least one second positive voltage signal line are both electrically connected to the positive voltage signal bus, and a line width of the first positive voltage signal line is less than a line width of the second positive voltage signal line; or
a first positive voltage signal bus and a second positive voltage signal bus, wherein the first positive voltage signal bus is arranged in the peripheral area, surrounds the display area, and is configured to transmit the first positive voltage signal; the second positive voltage signal bus is arranged in the peripheral area, surrounds the display area, and is configured to transmit the second positive voltage signal; wherein the first positive voltage signal lines are electrically connected to the first positive voltage signal bus, and the at least one second positive voltage signal line is electrically connected to the second positive voltage signal bus.

6. The display panel according to claim 4, wherein the display panel has a display area and a peripheral area, and the plurality of first sub-pixels and the plurality of second sub-pixels are located in the display area; the peripheral area surrounds the display area;
the display panel further comprises:
a positive voltage signal bus arranged in the peripheral area and surrounding the display area; wherein the first positive voltage signal lines and the second positive voltage signal lines are both electrically connected to the positive voltage signal bus, and a line width of the first positive voltage signal line is less than a line width of the second positive voltage signal line; or
a first positive voltage signal bus arranged in the peripheral area, surrounding the display area, and configured to transmit the first positive voltage signal and a second positive voltage signal bus arranged in the peripheral area, surrounding the display area, and configured to transmit the second positive voltage signal; wherein the first positive voltage signal lines are electrically connected to the first positive voltage signal bus, and the second positive voltage signal lines are electrically connected to the second positive voltage signal bus.

7. The display panel according to claim 1, wherein the first sub-pixel includes a first pixel circuit and a first light-emitting device, the first pixel circuit includes a first node, and the first node is electrically connected to the first light-emitting device; the second sub-pixel includes a second pixel circuit and a second light-emitting device, the second pixel circuit includes a second node, and the second node is electrically connected to the second light-emitting device;
the first signal lines include first initial voltage signal lines, a first initial voltage signal line is configured to transmit the first initial voltage signal and is configured to initialize the first node;
the second signal lines include at least one second initial voltage signal line. a second initial voltage signal line is configured to transmit the second initial voltage signal and is configured to initialize the second node;
a voltage value of the first initial voltage signal is less than a voltage value of the second initial voltage signal.

8. The display panel according to claim 7, wherein
the plurality of second sub-pixels surround the plurality of first sub-pixels;
the at least one second initial voltage signal line each extend along a peripheral edge of the plurality of first sub-pixels and the at least one second initial voltage signal line is electrically connected to the plurality of second sub-pixels;
the display panel comprises a plurality of conductive layers, wherein the first initial voltage signal lines and the at least one second initial voltage signal line are located in different conductive layers.

9. The display panel according to claim 7, wherein
the at least part of the plurality of second sub-pixels are arranged in a plurality of rows, and at least one row of second sub-pixels is arranged on each of both sides, in a second direction, of the plurality of first sub-pixels; a row of second sub-pixels includes second sub-pixels arranged in a first direction; the first direction and the second direction intersect;
the display panel comprises a plurality of second initial voltage signal lines, wherein each second initial voltage signal line is electrically connected to a respective row of second sub-pixels; and
the display panel comprises a plurality of conductive layers, wherein the first initial voltage signal lines and the second initial voltage signal lines are arranged in the same layer.

10. The display panel according to claim 1, wherein the first sub-pixel includes a first light-emitting device, and the second sub-pixel includes a second light-emitting device;
the first signal lines include a first negative voltage signal line, the first negative voltage signal line is configured to transmit the first negative voltage signal and is configured to be electrically connected to a cathode of the first light-emitting device; and
the second signal lines-include a second negative voltage signal line, the second negative voltage signal line is configured to transmit the second negative voltage signal and is configured to be electrically connected to a cathode of the second light-emitting device;
wherein a voltage value of the first negative voltage signal is less than a voltage value of the second negative voltage signal.

11. The display panel according to claim 10, wherein the first negative voltage signal line and the second negative voltage signal line are arranged in a same layer, and the first negative voltage signal line and the second negative voltage signal line have a gap therebetween.

12. The display panel according to claim 1, wherein
the first signal lines include first data signal lines, a first data signal line is configured to transmit the data signal; and the second signal lines include second data signal lines. a second signal line is configured to transmit the signal;
wherein a resistance of the first data signal line is less than a resistance of the second data signal line.

13. The display panel according to claim 12, wherein
the plurality of second sub-pixels surround the plurality of first sub-pixels;
the display panel comprises a plurality of conductive layers, wherein the first data signal lines and the second data signal lines are located in different conductive layers, and a resistivity of a material of the first data signal lines is less than a resistivity of a material of the second data signal lines.

14. The display panel according to claim 12, wherein the at least part of the plurality of second sub-pixels are arranged in a plurality of columns, and at least one column of second sub-pixels is arranged on each of both sides, in a first direction, of the plurality of first sub-pixels; a column of second sub-pixels includes second sub-pixels arranged in a second direction; the first direction and the second direction intersect;
each second data signal line is electrically connected to a respective column of second sub-pixels;
the display panel comprises a plurality of conductive layers, wherein the first data signal lines and the second data signal lines are located in a same conductive layer, and a line width of the first data signal line is greater than a line width of the second data signal line.

15. The display panel according to claim 1, wherein the first sub-pixel includes a first driving transistor and a first capacitor, and a plate of the first capacitor is electrically connected to a gate of the first driving transistor; the second sub-pixel includes a second driving transistor and a second capacitor, and a plate of the second capacitor is electrically connected to a gate of the second driving transistor; wherein
a capacitance of the second capacitor is greater than a capacitance of the first capacitor.

16. The display panel according to claim 15, wherein a facing area between at least two plates included in the second capacitor is greater than a facing area between at least two plates included in the first capacitor.

17. The display panel according to claim 15, a number of plates included in the second capacitor is greater than a number of plates included in the first capacitor.

18. The display panel according to claim 1, wherein the first sub-circuit includes a first driving transistor, and the second sub-circuit includes a second driving transistor, wherein
a width-to-length ratio of a channel structure of the first driving transistor is less than a width-to-length ratio of a channel structure of the second driving transistor.

19. The display panel according to claim 1, wherein the display panel has a display area and a bonding area located on a side of the display area, and the bonding area is provided with connection pins and dummy pins therein;
the first signal lines are electrically connected to the connection pins, and the second signal lines are electrically connected to the connection pins and/or the dummy pins.

20. A display apparatus, comprising a plurality of display panels each according to claim 1, wherein two adjacent display panels have a seam therebetween, a display panel of the two adjacent display panels includes a first side proximate to the seam, and second sub-pixels in the display panel are closer to the first side than first sub-pixels in the display panel.
